(19) United States
(12) Patent Application Publication
(10) Pub. No.: US 2002/0073169 A1
(43) Pub. Date: Jun. 13, 2002

(54) Information processing apparatus, information processing system and method thereof

(76) Inventors: Yoshiyuki Takaku, Tokyo (JP); Makoto Sato, Tokyo (JP)

Correspondence Address: LERNER, DAVID, LITTENBERG,, KRUMHOLZ & MENTLIK, LLP, 600 SOUTH AVENUE WEST, WESTFIELD, NJ, 07090-1497, US

(21) Appl. No.: 09/834,020

(22) Filed: Apr. 12, 2001

(30) Foreign Application Priority Data
Apr. 12, 2000 (JP) P2000-111261

(51) Int. Cl. G06F 15/16

(52) U.S. Cl. 709/217

(57) ABSTRACT

In an information processing system, processing in a network is significantly reduced compared with conventional methods. Information is transmitted from an information processing apparatus to an information receiving apparatus via a transmission channel established between the information receiving apparatus and the information processing apparatus. The information receiving apparatus is able to easily acquire the information input to the information processing apparatus, and thus it can further reduce processing in a network compared with conventional methods.

### CROSS-REFERENCE TO RELATED APPLICATIONS

The present application claims priority from Japanese Application No. P2000-111261 filed Apr. 12, 2000, the disclosure of which is hereby incorporated by reference herein.

### BACKGROUND OF THE INVENTION

This invention relates to an information processing apparatus, an information processing system and a method thereof, and is suited to, for instance, an audio visual (AV) system connecting various AV apparatus.

In recent years, the IEEE (Institute of Electrical Electronics Engineers) has been working on the standardization of the so-called IEEE1394 high performance serial bus (hereafter referred to as the IEEE1394 serial bus), known as a high speed serial bus, and has proposed that an AV system as a home network should be constructed by using the IEEE1394 serial bus to connect various AV apparatus existing at home.

Such an AV system is constructed, for instance, by connecting one mini disk (MD) player and one audio amplifier (hereafter referred to as an audio amp), respectively, to an IEEE1394 serial bus, and also connecting a plurality of compact disk (CD) players thereto, where desired audio data is reproduced from a CD player selected by a user from the plurality of CD players and the reproduced audio data is sent to an MD player and recorded thereon.

Incidentally, various AV apparatus connected with this IEEE1394 serial bus have a concept called plug introduced with a logical input plug equivalent to a physical external input terminal and a logical output plug equivalent to a physical external output terminal in order to form a transmission path for transmitting audio data on the IEEE1394 serial bus.

Thus, in an AV system connecting such various AV apparatus with this IEEE1394 serial bus, if a desired CD player is specified from the plurarity of CD players as an AV apparatus on the output side and an MD player is specified as an AV apparatus on the input side, a band and a channel are secured for data transmission between the logical output plug of the CD player and the logical input plug of the MD player, and also the logical output plug of the CD player and the logical input plug of the MD player are logically connected (hereafter referred to as logical connection) to transmit audio data from the CD player to the MD player. To be more specific, the MD player on the input side first examines channels input to the logical input plug, and searches for the logical output plug of the CD player using the same channel as the input channel so as to logically connect the logical input plug of the MD player with the logical output plug of the searched-for CD player.

Thus, there is a problem that the process required for logical connection inevitably becomes complicated since an MD player logically connects its own logical input plug with the logical output plug of the CD player and thus the logical output plug of the CD player must be searched for.

Moreover, in the AV system, there are cases where a logical output plug for outputting audio data to be supplied to a logical input plug of the audio amp is changed by changing the CD player on the output side, for instance. Thus, the MD player on the input side must always supervise the change of this logical output plug and change the logical connection if there is a change, and so there is a problem that the process required for logical connection inevitably becomes complicated.

### SUMMARY OF THE INVENTION

In view of the foregoing, an object of this invention is to provide an information processing apparatus, an information processing system and a method thereof capable of reducing processing required for logical connection as compared with conventional methods.

The foregoing object and other objects of the invention have been achieved by the provision of an information processing system for connecting an information sending apparatus, an information processing apparatus and an information receiving apparatus to an information transmitting system having a plurality of transmission channels. Information sent from any of a plurality of information sending apparatus is transmitted to the information processing apparatus via a desired transmission channel, and is received from the information processing apparatus by the information receiving apparatus. The information processing apparatus is equipped with an information supply unit operable to supply information input via an input unit connected to the information transmitting system to an output unit connected to the information transmitting system. Information transmitted to the information processing apparatus from the information sending apparatus via a first transmission channel is transmitted to the information receiving apparatus via a second transmission channel established between the information receiving apparatus and the information processing apparatus.

Information transmitted to the information processing apparatus from the information sending apparatus via the first transmission channel and input to the input unit of the information processing apparatus can easily be acquired by the information receiving apparatus by transmitting the information to the information receiving apparatus from the information processing apparatus via a second transmission channel established between the above information receiving apparatus and the above information processing apparatus.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a block diagram showing an embodiment of an information processing system according to this invention;

FIG. 2 is an illustration showing an example of a cycle structure of data transmission in an IEEE1394-method bus;

FIG. 3 is an illustration showing examples of the address space structure of CSR architecture of a 1394 node;

FIG. 4 is an illustration showing examples of positions, names and operations of the main CSRs;

FIG. 5 is an illustration showing an example of a general ROM format;

FIG. 6 is an illustration showing examples of a bus info block, a root directory and a unit directory;

FIG. 7 is an illustration showing an example of the configuration of PCRs;

FIGS. 8A to 8D are illustrations showing examples of the configurations of an oMPR, an oPCR, an iMPR and an iPCR, respectively;

FIG. 9 is an illustration showing an example of a relationship among a plug, a plug control register and a transmission channel;

FIG. 10 is an illustration showing an example of a data structure by a hierarchical structure of descriptors;

FIG. 11 is an illustration showing an example of a data format of descriptors;

FIG. 12 is an illustration showing examples of the generation ID of FIG. 11;

FIG. 13 is an illustration showing examples of the list ID of FIG. 11;

FIG. 14 is an illustration showing an example of a stack model of an AV/C command;

FIG. 15 is an illustration showing a relationship between a command and a response of FCP;

FIG. 16 is an illustration showing a relationship between a command and a response of FIG. 15 in further detail;

FIG. 17 is an illustration showing an example of a data structure of an AV/C command;

FIGS. 18A to 18C are illustrations showing concrete examples of AV/C commands;

FIGS. 19A and 19B are illustrations showing concrete examples of commands and responses of AV/C commands;

FIG. 20 is a block diagram showing a configuration of an audio amp;

FIG. 21 is a schematic diagram showing a configuration of an AV system;

FIG. 22 is a schematic diagram showing an example of a logical connection; and

FIG. 23 is a schematic diagram showing another example of a logical connection.

### DETAILED DESCRIPTION

Preferred embodiments of this invention will be described with reference to the accompanied drawings.

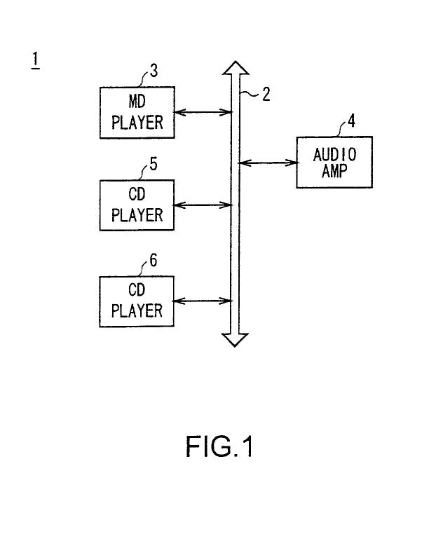

In FIG. 1, 1 shows the configuration of an AV system as a whole, which is constructed by connecting a Mini Disk (MD) player 3 as an information receiving apparatus, an audio amplifier (hereafter referred to as an audio amp) 4 as an information processing apparatus, and Compact Disk (CD) players 5 and 6 as information sending apparatus to an IEEE1394 high performance serial bus 2 (hereafter referred to as an IEEE1394 serial bus) via external terminals of an IEEE1394 structure (hereafter referred to as IEEE1394 terminals), respectively.

This AV system reproduces desired audio data from a CD player selected by a user out of the two CD players 5 and 6, and transfers the reproduced data to the MD player 3 via, in sequence, the IEEE1394 serial bus 2, the audio amp 4 and the IEEE1394 serial bus 2 to record it thereon.

Incidentally, in the IEEE1394 serial bus 2, a synchronous transport mode assuring a transfer band called isochronous is defined as a transfer operation performed in a network so as to allow data transfer that is assured to be real-time.

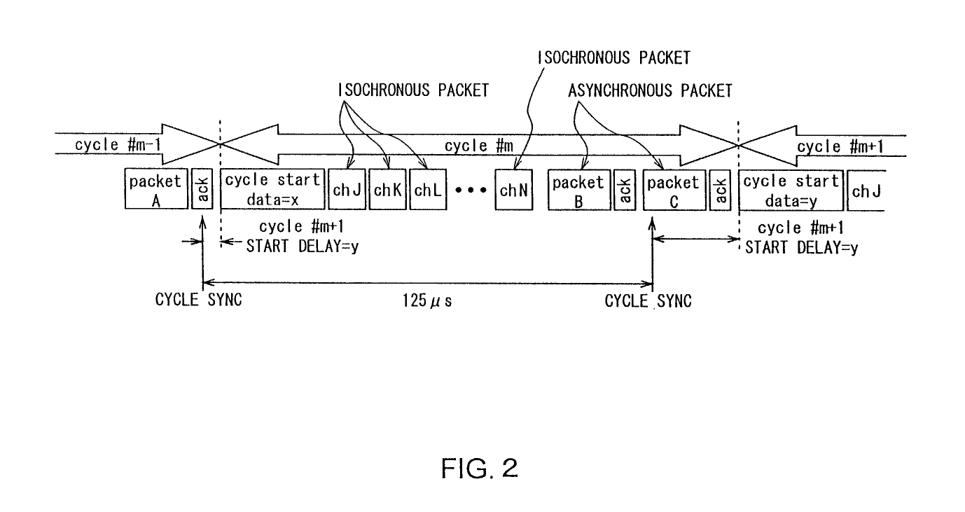

FIG. 2 is a diagram showing the structure of a data transmission cycle for apparatus connected by IEEE1394 terminals. In the IEEE1394 system, data is divided into packets and is transmitted by time division with reference to a cycle of 125 μs length. This cycle is created by a cycle start signal supplied from a node (any apparatus connected with the bus) having a cycle master function. An isochronous packet secures a band (called a band though it is a time unit) required for transmission from the first portion of every cycle. Thus, in isochronous transmission, transmission of data within a fixed time is assured. In case a transmission error occurs, however, data is lost since there is no arrangement for data protection. In asynchronous transmission, on the other hand, the node sends the asynchronous packet when it has obtained the right to use the bus as a result of arbitration during the time when the bus is not used for isochronous transmission in each cycle. Reliable transmission is possible by using acknowledge and retry, but the time of transmission is not fixed.

For a predetermined node to execute isochronous transmission, the node must support an isochronous function. Moreover, at least one of the nodes supporting the isochronous function must also have a cycle master function. Furthermore, at least one of the nodes connected to IEEE1394 serial bus 2 must have an isochronous resource managing function.

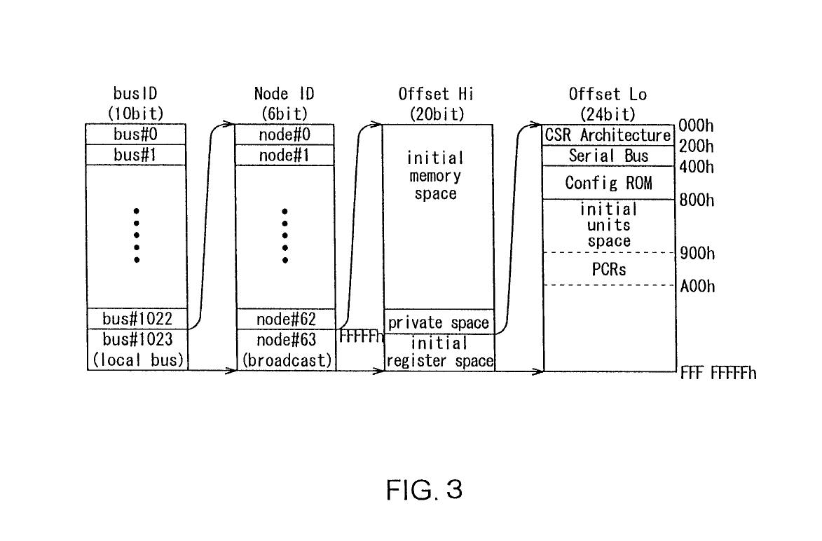

IEEE1394 complies with the CSR (Control & Status Register) architecture defined by the ISO/IEC13213 standard for 64-bit fixed addressing. FIG. 3 is a diagram explaining the structure of the address space of the CSR architecture. The first 16 bits in each address are node IDs indicating the nodes on the respective IEEE1394 bus, and the remaining 48 bits are used to specify address spaces given to the nodes. The node ID designates the bus ID by its first 10 bits, and designates the physical ID (a node ID in a narrow sense) by its next 6 bits. The bus 10 and the physical ID use the value obtained when all bits are set to 1 for a special purpose. Therefore, this addressing method enables 1023 buses and 63 nodes to be specified.

In the remaining 48 bits of the address space defining 256 terabytes, the space defined by the first 20 bits is divided into an initial register space which is used for a register unique to a CSR of 2048 bytes and a register unique to the IEEE1394 standard, a private space and an initial memory space. The space defined by the remaining 28 bits is used, when the space defined by the first 20 bits is an initial register space, as a configuration read only memory (ROM), an initial unit space for a use specific to the node, plug control registers (PCRs), and so on.

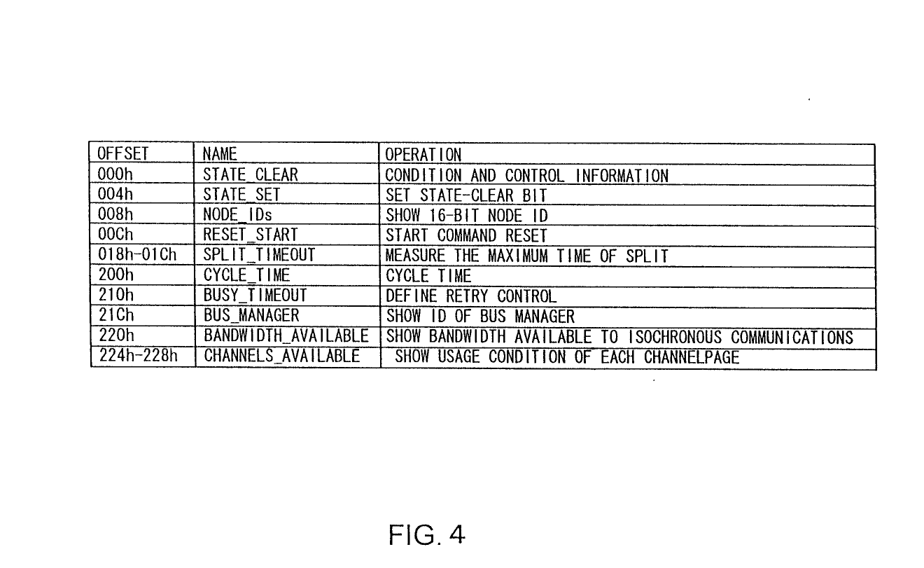

FIG. 4 is a diagram explaining offset addresses, names and functions of major CSRs. The term “offset” in FIG. 4 indicates an offset address relative to the FFFFF0000000h address (a number with an h at the end represents a hexadecimal numeral) at which the initial register space begins. The bandwidth available register having an offset of 220h indicates a bandwidth allocatable to isochronous communication, and recognizes only the value of the node operating as an isochronous resource manager to be effective. To be more specific, while each of the nodes has a CSR architecture such as shown in FIG. 3, the bandwidth available register in only the isochronous resource manager is recognized to be effective. In other words, only the isochronous resource manager actually has the bandwidth available register. The bandwidth available register has a maximum value stored when no bandwidth has been allocated to isochronous communication, and the value is decreased every time a bandwidth is allocated to isochronous communication.

The channels available register from offset 224h to 228h, correspond to channel numbers with 10 to 63 bits, respectively. A channel number with 0 bits indicates that the channel has already been allocated to the channels available register. The channels available register is effective only in the node operating as the isochronous resource manager.

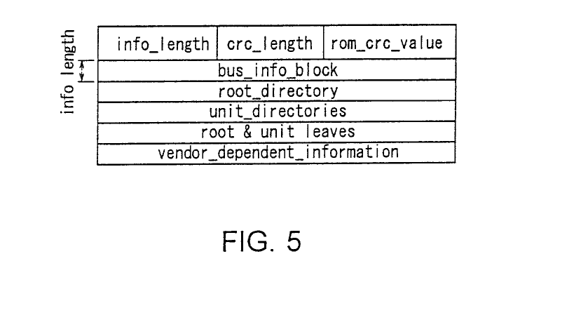

Returning to FIG. 3, a configuration read only memory (ROM) based on a general ROM format is arranged in the addresses 200 to 400h within the initial register space. FIG. 5 is a diagram explaining the general ROM format. A node which is a unit of access on the IEEE1394 bus can have a plurality of units that operate independently while using a common address space in the node. The unit directories field can indicate the version and the position of the software for the unit. While the positions of the bus info block and the root directory are fixed, the positions of the other blocks are specified by the offset addresses.

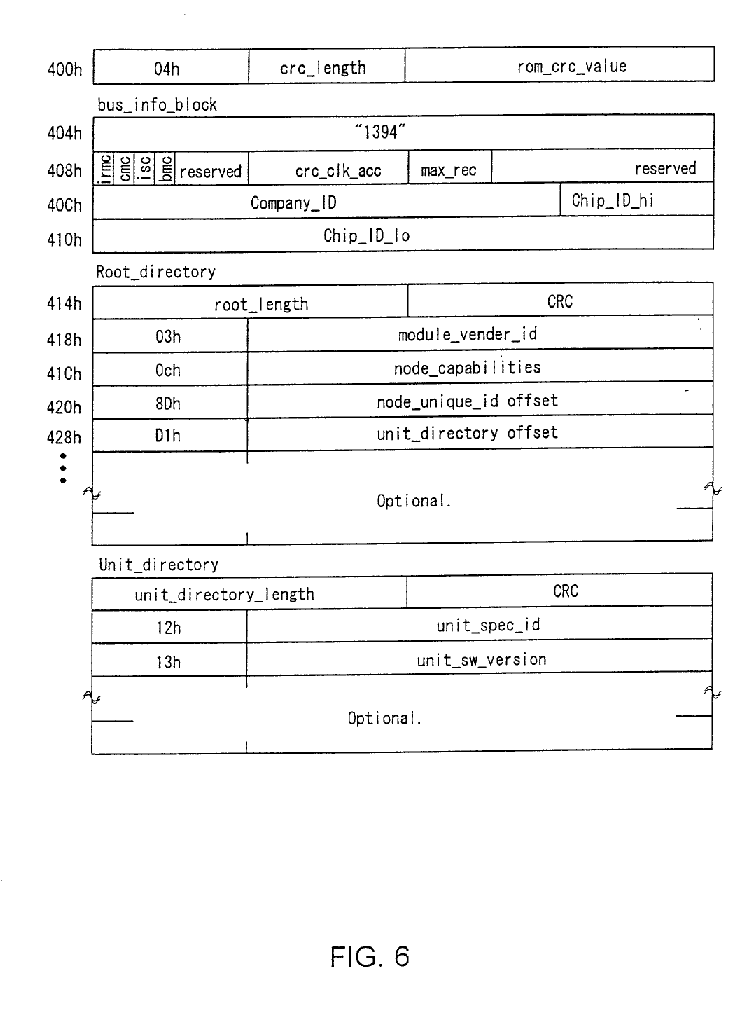

FIG. 6 is a diagram showing details of the bus info block, root directory and unit directory. The Company ID field in the bus info block stores an ID number indicating the manufacturer of the apparatus. The Chip ID field stores an ID unique to that apparatus and the only one ID in the world which does not overlap with any other IDs. In addition, 00h is written into the first octet of the unit spec ID field of the unit directory of apparatus meeting the IEC61883 standard, Aoh is written into the second octet thereof, and 2Dh is written into the third octet thereof. Furthermore, 01h is written into the first octet of the unit switch version field, and 1 is written into the least significant bit (LSB) of the third octet.

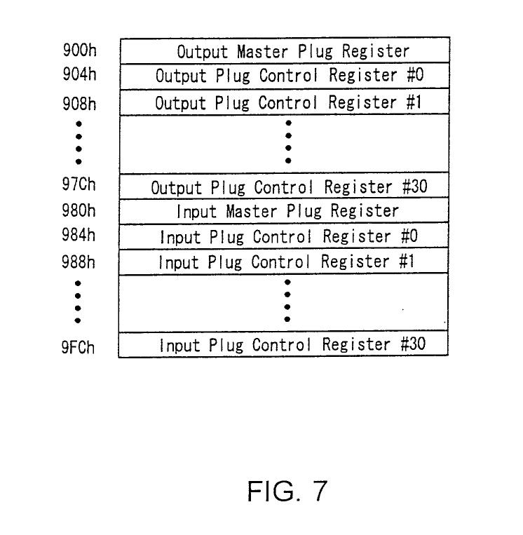

In order to control input-output of an apparatus via an interface, the node has a plug control register (PCR) defined by the IEC61883 standard in the addresses 900h to 9FFh within the initial unit space shown in FIG. 3. This design embodies the concept of a plug substantiated to form a signal path logically similar to an analog interface. FIG. 7 is a diagram explaining the configuration of a PCR. The PCR has an output plug control register (OPCR) representing an output plug and an input plug control register (iPCR) representing an input plug. In addition, the PCR has an output master plug register (OMPR) and an input master plug register (iMPR) indicating information of an output plug or an input plug unique to each apparatus. While each apparatus does not have a plurality of oMPRs and iMPRs, it is possible to have a plurality of oPCRs and iPCRs corresponding to individual plugs depending on the ability of the apparatus. Each of the PCRs shown in FIG. 7 has 31 oPCRs and iPCRs, respectively. The flow of isochronous data is controlled by manipulating the registers corresponding to these plugs.

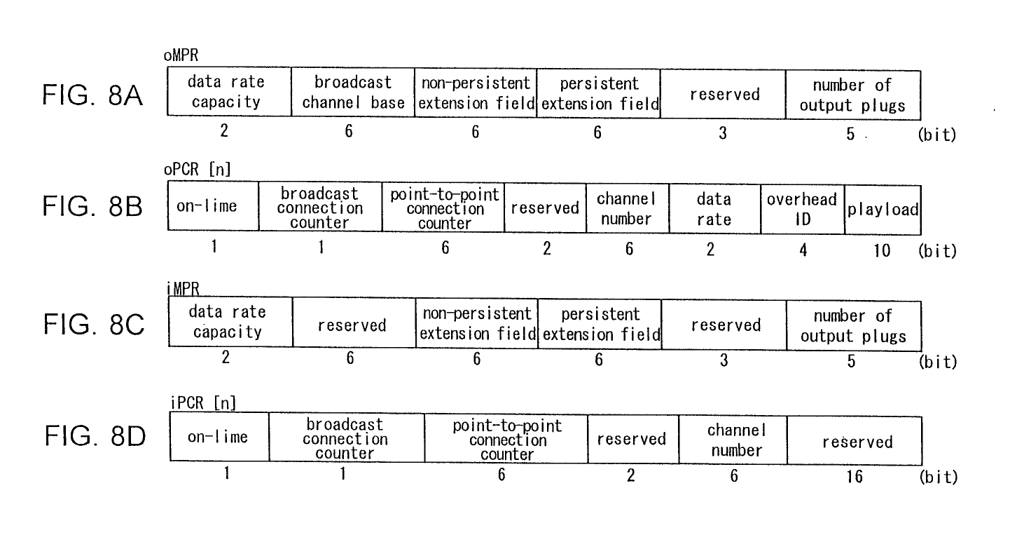

FIGS. 8A to 8D are diagrams showing the configurations of an OMPR, an OPCR, an iMPR and an iPCR, respectively. FIG. 8A shows the configuration of an oMPR, FIG. 8B shows the configuration of an OPCR, FIG. 8C shows the configuration of an iMPR, and FIG. 8D shows the configuration of an iPCR. A code indicating the maximum transmission rate of isochronous data that the apparatus can send or receive is stored in the 2-bit data rate capability field on the MSB side of the oMPR and iMPR. A broadcast channel base field in the OMPR defines the channel number to be used for broadcast output.

The 5-bit number of output plugs field on the LSB side of the oMPR stores a value showing the number of output plugs that the apparatus has, that is, the number of oPCRs. The 5-bit number of input plugs field on the LSB side of the iMPR stores a value showing the number of input plugs that the apparatus has, that is, the number of iPCRs. A non-persistent extension field and a persistent extension field are domains defined for future expansion.

An on-line field on the MSB side of the oPCR and iPCR indicates a state of use of a plug. To be more specific, a value of 1 in the on-line field indicates that the plug is in an on-line state, and a value of 0 in the on-line field indicates that the plug is in an off-line state. The values in the broadcast connection counter fields of both the oPCR and iPCR represent the presence (a value of 1) or absence (value of 0) of a broadcast connection. The values in the 6-bit point-to-point connection counter fields of both the oPCR and iPCR represent the number of point-to-point connections that the plug has.

The values in the 6-bit channel number fields in both the oPCR and IPCR indicate the number of the isochronous channel to which the plug is connected. The value in the 2-bit data rate field in the OPCR indicates an actual transmission rate of packets of isochronous data to be output from the plug. The code stored in the 4-bit overhead ID field in the oPCR indicates the bandwidth over the isochronous communication. The value in the 10-bit payload field in the OPCR indicates the maximum value of the data contained in the isochronous packets that the plug can handle.

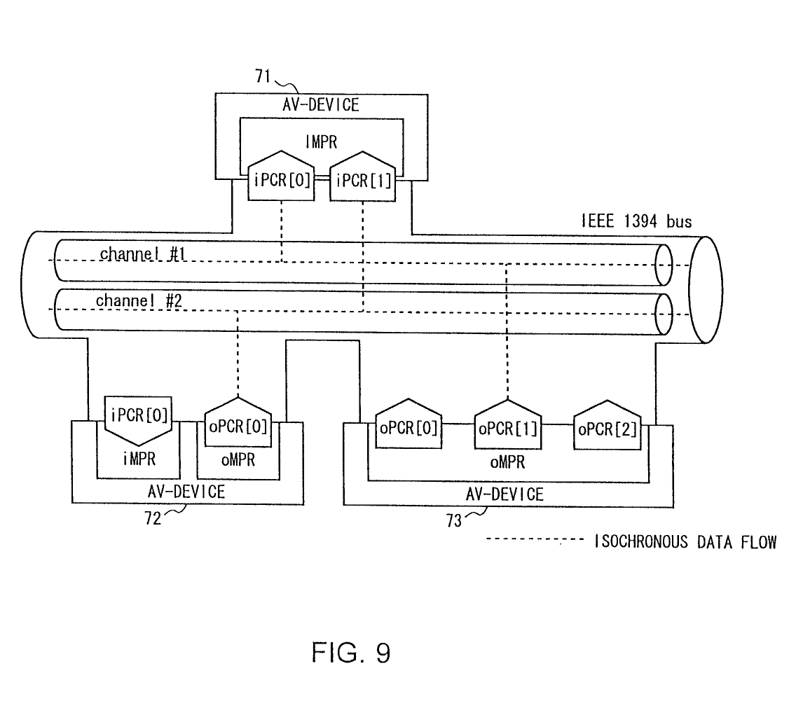

FIG. 9 is a diagram showing the relationship among a plug, a plug control register and an isochronous channel. AV devices 71 to 73 are connected to each other by an IEEE1394 serial bus. The oMPR in the AV device 73 defines the number and transmission rate of the OPCR [0] to oPCR [2] in the device. The isochronous data for which the channel is specified by oPCR [1] is sent to channel #1 in the IEEE1394 serial bus. The iMPR in the AV device 71 defines the number and transmission rate of iPCR [0] and iPCR [1] therein. The AV device 71 reads the isochronous data sent to channel #1 of the IEEE1394 serial bus as designated by iPCR [0]. Likewise, AV device 72 sends isochronous data to channel #2 as specified by OPCR [0], and AV device 71 reads the isochronous data from channel #2 as specified by iPCR [1].

In accordance with the foregoing description, data transmission is executed among the apparatus connected to each other by the IEEE1394 serial bus. In this system, each apparatus can be controlled and the state thereof can be determined by use of an AV/C command set defined as commands for controlling the apparatus connected to each other by the IEEE1394 serial bus. This AV/C command set will be described next.

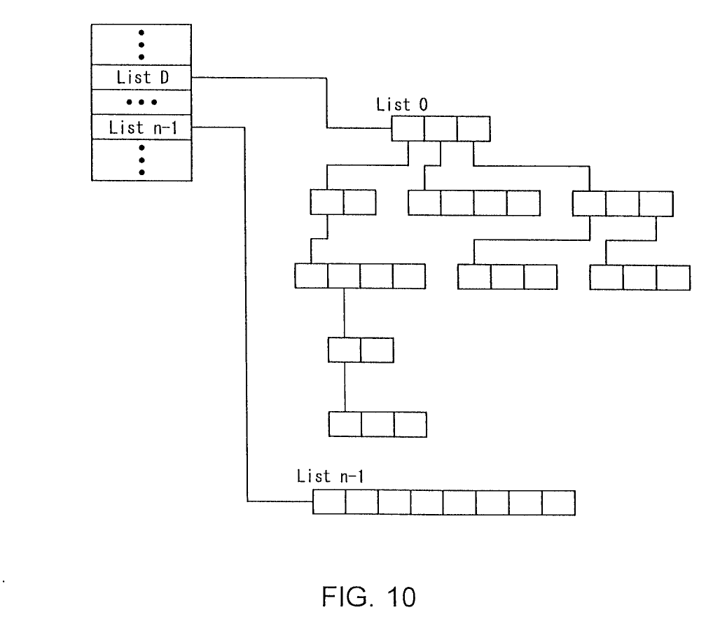

First, a data structure of the Subunit Identifier Descriptor in the AV/C command set used in the system of this example will be described by referring to FIGS. 10 to 13. FIG. 10 shows the data structure of the Subunit Identifier Descriptor. As shown in FIG. 10, the data structure of the Subunit Identifier Descriptor consists of hierarchical lists. For instance, in the case of a tuner, a list represents channels through which data can be received, and in the case of a disk, a list represents music recorded thereon. The uppermost list in the hierarchy is called a root list; for instance, list 0 is a root for its subordinate lists. Lists 2 to (n−1) are also root lists. There are as many root lists as there are objects. In the case where the AV apparatus is a tuner, the objects are the channels in a digital broadcast. In addition, all the lists of one layer share the same information.

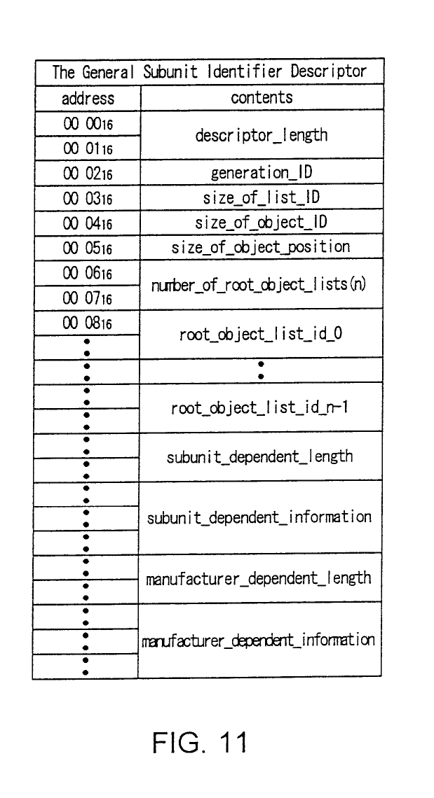

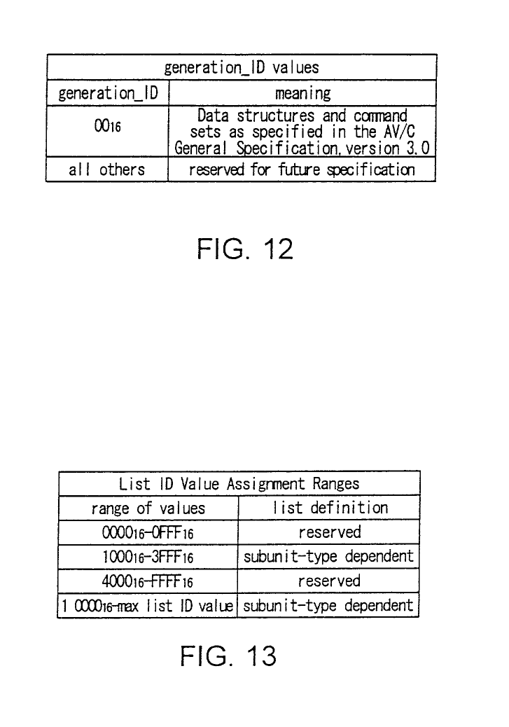

FIG. 11 shows a format of the General Subunit Identifier Descriptor used in an existing system. A Subunit Identifier Descriptor has contents including attribute information on functions. It does not include a value of the descriptor length field itself. The generation ID field indicates the version of the AV/C command set of which value is currently “00h” (h represents hexadecimal) as shown in FIG. 12. Here, “00h” means that the data structure and command set are version 3.0 of AV/C General Specification. In addition, as shown in FIG. 12, all the values except “00h” are reserved for future specification.

The size of list ID field indicates the number of bytes of the list ID. The size of object ID field indicates the number of bytes of the object ID. The size of object position field indicates the position (the number of bytes) in the lists to be referenced in a control operation. The number of root object lists field indicates the number of root object lists. The root object list id field indicates an ID for identifying the uppermost root object list in the independent layers in the hierarchy.

The subunit dependent length field indicates the number of bytes in a subsequent subunit dependent information field. The subunit dependent information field indicates information unique to the functions. The manufacturer dependent length field indicates the number of bytes in a subsequent manufacturer dependent information field. The manufacturer dependent information field indicates specification information of a vendor (a manufacturer). In the case where there is no manufacturer dependent information in the descriptor, this field does not exist.

FIG. 13 indicates the assignment ranges of the list IDs shown in FIG. 11. As shown in FIG. 13, the values at “0000h to 0FFFh” and “4000h to FFFFh” are reserved for future specification. The values at “1000h to 3FFFh” and “10000h to max list ID value” are prepared for identifying dependent information of a function type.

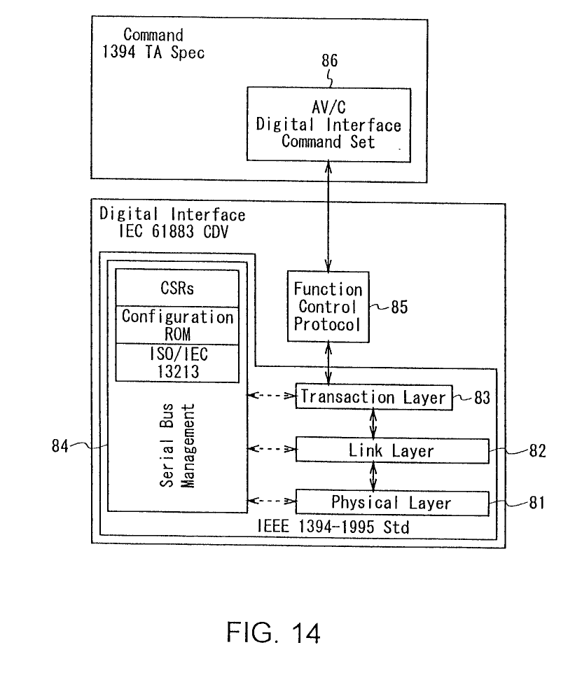

Next, the AV/C command set used in the system of this example will be described by referring to FIGS. 14 to 19. FIG. 14 shows a stack model of the AV/C command set. As shown in FIG. 14, a physical layer 81, a link layer 82, a transaction layer 83 and a serial bus management 84 are in compliance with the IEEE1394 standard. An FCP (Function Control Protocol) 85 is in compliance with the IEC61883 standard. An AV/C command set 86 is in compliance with the 1394TA specification.

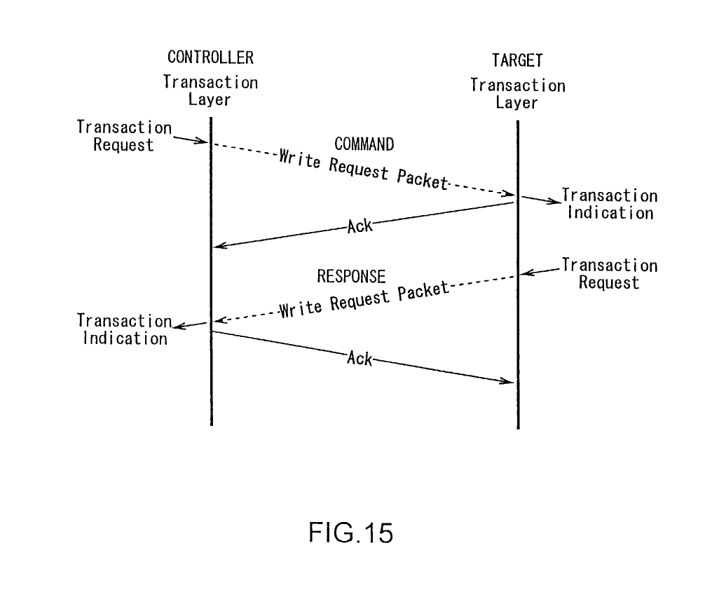

FIG. 15 is a diagram for explaining a command and a response of the FCP 85 of FIG. 14. FCP is a protocol for controlling the AV apparatus in conformity with the IEEE1394 standard. As shown in FIG. 15, the controlling side is a controller and the controlled side is a target. In the FCP, a command is sent and received between nodes by using the write transaction in the IEEE1394 asynchronous communication. Upon receiving data from the controller, the target returns an acknowledgement to the controller to confirm receipt.

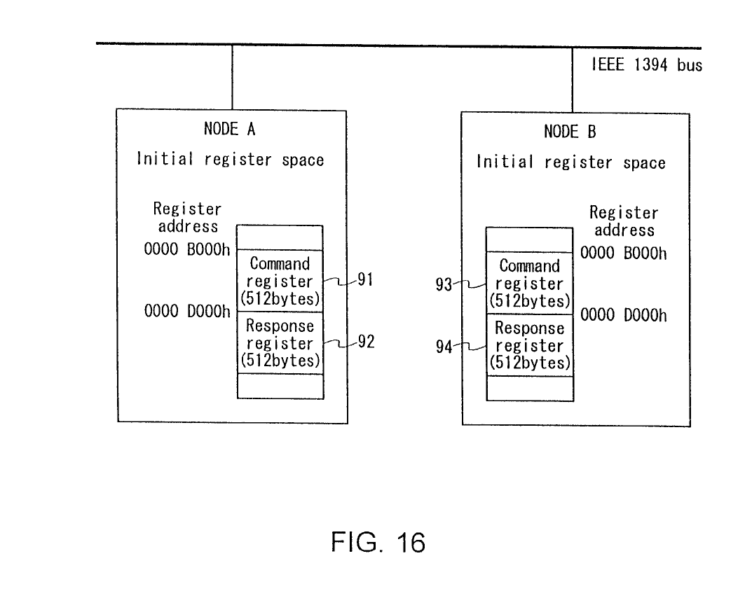

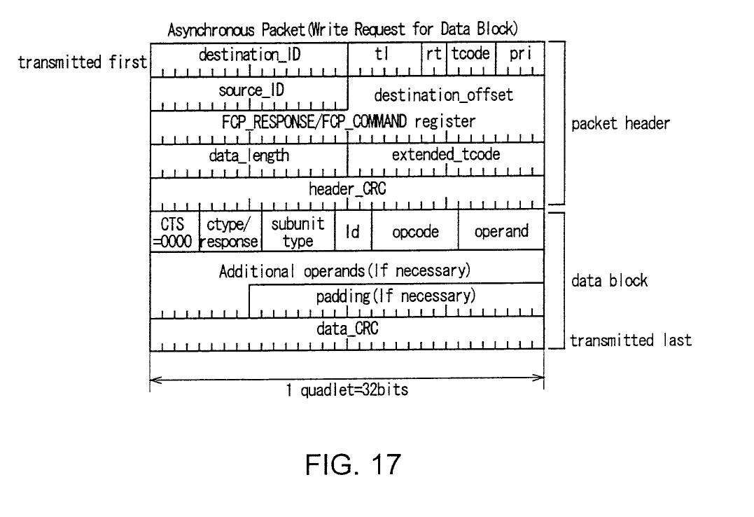

FIG. 16 is a diagram for further explaining the relationship between a command and a response of the FCP shown in FIG. 15. Node A and node B are connected via an IEEE1394 bus. Node A is a controller and node B is a target. Both node A and node B have a command register and a response register of 512 bytes, respectively. As shown in FIG. 16, the controller writes a command message to a command register 93 in the target to convey a command thereto. Conversely, the target writes a response message to the response register 92 in the controller to convey a response. Between these two messages, control information is exchanged. The type of the command set sent by FCP is written in the CTS in a data field shown in FIG. 17.

FIG. 17 shows the data structure of a packet transmitted in an asynchronous transfer mode of the AV/C command. The AV/C command set is a command set for controlling an AV apparatus where the CTS (command set ID) =“0000.” An AV/C command frame and a response frame are exchanged between nodes by using the FCP described above. In order not to place a burden on the bus and the AV apparatus, a response to the command is performed within 100 ms. As shown in FIG. 17, the asynchronous data packet consists of 32 bits in a horizontal direction (=1 quadlet). The upper part of the diagram shows a header portion of the packet, and the lower part of the diagram shows a data block. The destination_ID field indicates a destination.

The CTS field indicates the ID of a command set, wherein CTS=“0000” for the AV/C command set. The ctype/response field indicates the function classification of a command when the packet is a command, and indicates the results of command processing where the packet is a response. Commands are roughly classified into four categories: (1) a command for controlling a function from outside (CONTROL); (2) a command for inquiring as to the state from the outside (STATUS); (3) a command for inquiring as to whether there is support for a control command from the outside (GENERAL INQUIRY for inquiring as to whether there is support for opcode, and SPECIFIC INQUIRY for inquiring as to whether there is support for opcode and operands); and (4) a command for requesting notification to the outside as to a change in state (NOTIFY).

A response is returned according to the type of the command. Responses to a CONTROL command are NOT IMPLEMENTED, ACCEPTED, REJECTED and INTERIM. Responses to a STATUS command are NOT IMPLEMENTED, REJECTED, IN TRANSITION and STABLE. Responses to GENERAL INQUIRY and SPECIFIC INQUIRY commands are IMPLEMENTED and NOT IMPLEMENTED. Responses to a NOTIFY command are NOT IMPLEMENTED, REJECTED, INTERIM and CHANGED.

A subunit type field is provided in order to identify the function of an apparatus and, for instance, is assigned to identify a tape recorder/player, a tuner and so on. In order to distinguish each subunit from the others in the case where there are a plurality of subunits of the same type, addressing is executed by using a subunit id as an identification number. The opcode field indicates a command, and the operand field indicates a parameter of the command. Additional operands fields are added as required. The padding also is added as required. The data CRC (Cyclic Redundancy Check) field is used for an error check in data transmission.

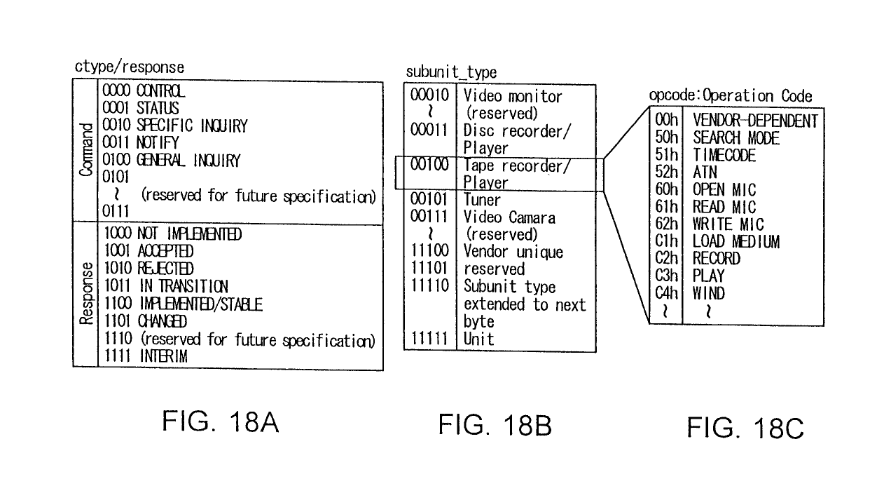

FIGS. 18A to 18C show specific examples of AV/C commands. FIG. 18A shows a specific example of the ctype/response field. The upper part of the diagram represents commands, while the lower part of the diagram represents responses. The CONTROL command is assigned to “0000,” the STATUS command is assigned to “0001,” the SPECIFIC INQUIRY command is assigned to “0010,” the NOTIFY command is assigned to “0011,” and the GENERAL INQUIRY command is assigned to “0100.” “0101 to 0111” are reserved for future specification. In addition, the NOT IMPLEMENTED response is assigned to “1000,” the ACCEPTED response is assigned to “1001,” the REJECTED response is assigned to “1010,” the IN TRANSITION response is assigned to “1011,” the IMPLEMENTED/STABLE response is assigned to “1100,” the CHANGED response is assigned to “1101,” and the INTERIM response is assigned to “1111.” “1110” is reserved for future specification.

FIG. 18B shows a specific example of the subunit type field. Video monitor is assigned to “00000,” Disk recorder/Player is assigned to “00011,” Tape recorder/Player is assigned to “00100,” Tuner is assigned to “00101,” Video Camera is assigned to “00111,” Vendor unique is assigned to “11100,” and Subunit type extended to next byte is assigned to “11110.” Moreover, while Unit is assigned to “11111,” it is used in the case of sending data to an apparatus itself, such as turning the power on and off.

FIG. 18C shows a specific example of the opcode field. There is an opcode table for each of the subunit types, and FIG. 18C shows the opcode table in the case where the subunit type is a tape recorder/player. In addition, an operand is defined for each opcode. In the example of FIG. 18C, VENDOR-DEPENDENT is assigned to “00h,” SEARCH MODE is assigned to “50h,” TIMECODE is assigned to “51h,” ATN is assigned to “52h,” OPEN MIC is assigned to “60h,” READ MIC is assigned to “61h,” WRITE MIC is assigned to “62h,” LOAD MEDIUM is assigned to “C1h,” RECORD is assigned to “C2h,” PLAY is assigned to “C3h,” and WIND is assigned to “C4h.”

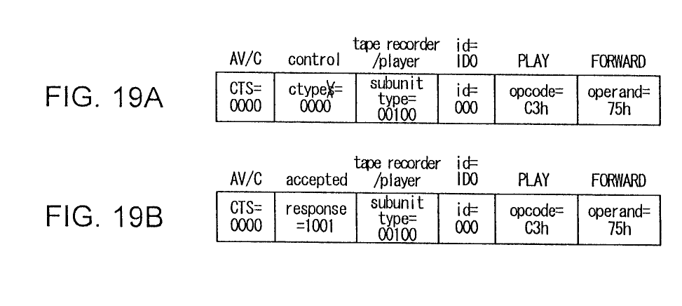

FIGS. 19A and 19B show specific examples of an AV/C command and a response. For instance, when an instruction for executing reproduction is given to a reproducing apparatus as a target (consumer), the controller sends a command such as shown in FIG. 19A to the target. As this command uses an AV/C command set, the CTS=“0000”. As the command for controlling the apparatus from the outside (CONTROL) is used for the ctype, the ctype=“0000” (see FIG. 18A). As the subunit type is a tape recorder/player, the subunit type=“00100” (see FIG. 18B). As the id indicates the case of ID0, the id=“000.” The opcode is “C3h” which means reproduction (play) (see FIG. 18C). The operand is “75h” which means FORWARD. And if reproduced, the target returns a response to the controller, such as shown in FIG. 19B. In the example shown in FIG. 19B, “accepted,” meaning that the data has been received, is part of the response and, therefore, the response=“1001” (see FIG. 18A). Except for the response, the other configurations of FIG. 27B are basically the same as in FIG. 27A and, therefore, their descriptions will be omitted.

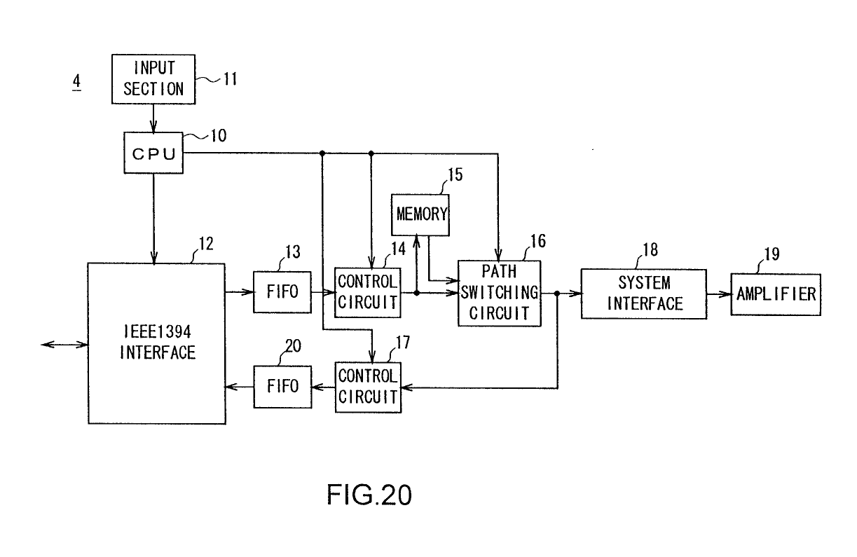

Next, FIG. 20 shows a circuit configuration of the audio amp 4. A CPU (Central Processing Unit) 10 is a circuit for controlling the entire audio amp 4, and controls operation of the circuits based on the operating instructions of a user entered from input section 11.

If audio data is supplied from the CD player 5 or 6 via the IEEE1394 serial bus 2, the audio amp 4 sends the audio data to a FIFO (First In First Out) 13 via an IEEE1394 interface 12 and stores it. A control circuit 14 reads the audio data from the FIFO 13 in a predetermined timing, and sends the read audio data to a memory 15 as information supplying means and to a path switching circuit 16.

Then the memory 15 is a circuit for adjusting the transmission rate of the audio data output from the CD player 5 or 6 wherein the transmission rate changes, and it stores the audio data supplied from the control circuit 14 once and then reads the audio data in a predetermined timing and sends it to the path switching circuit 16.

The path switching circuit 16 selects either the audio data supplied from the control circuit 14 or the audio data supplied from the memory 15 based on the operating instructions of the user entered through input section 11 via CPU 10, and sends the selected audio data to a control circuit 17 of the output system and to an amplifier 19 via a system interface 18.

The control circuit 17 writes the supplied audio data to a FIFO 20 in a predetermined timing and stores it. The FIFO 20 reads this stored audio data in a predetermined timing, and sends the read audio data to the MD player 3 via the IEEE1394 interface 12 and the IEEE1394 serial bus 2 in sequence.

On the other hand, amplifier 19 performs an equalizer process on the supplied audio data to amplify the signal level of a predetermined band and power amplification to adjust the volume level for driving a speaker, and outputs the resultant audio data to the outside.

Incidentally, each AV apparatus connected to the IEEE1394 serial bus 2 has a concept called plug introduced, as described earlier, in order to form a transmission path for transmitting audio data on the IEEE1394 serial bus 2, including a logical input plug (iPCR: input Plug Control Register) as input means equivalent to a physical external input terminal and a logical output plug (oPCR: output Plug Control Register) as output means equivalent to a physical external output terminal.

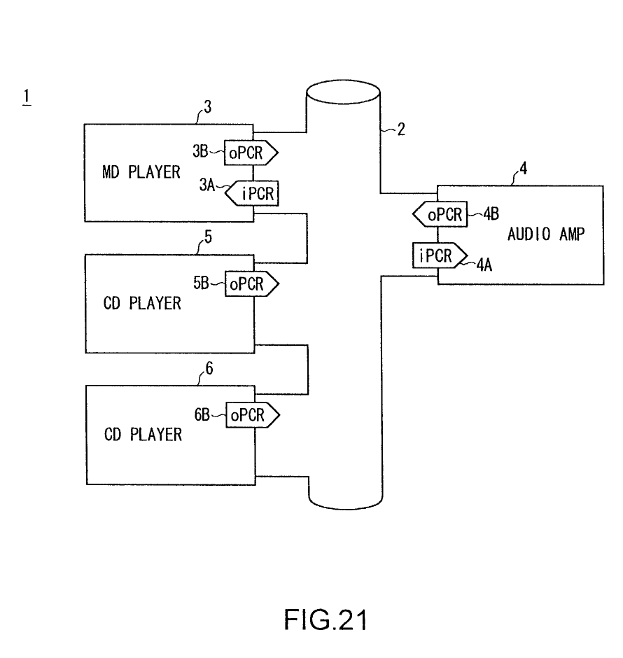

As shown in FIG. 21, in the AV system of FIG. 1, the MD player 3 has a logical input plug 3A and a logical output plug 3B, the audio amp 4 has a logical input plug 4A and a logical output plug 4B, the CD player 5 has a logical output plug 5B, and the CD player 6 has a logical output plug 6B.

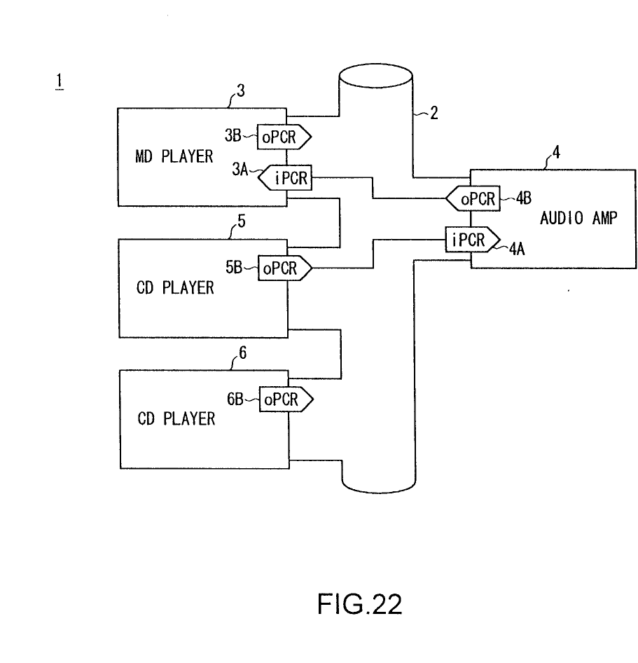

As shown in FIG. 22, if the user operation specifies the CD player 5 as an AV apparatus on the output side and the audio amp 4 as an AV apparatus on the input side, the CPU 10 of the audio amp 4 logically connects, by acquiring a band and a channel for isochronous transmission, the logical output plug 5B of the CD player 5 with the logical input plug 4A of the audio amp 4 (hereafter referred to as a logical connection).

Along with this, if the user operation specifies the audio amp 4 as an AV apparatus on the output side and the MD player 3 as an AV apparatus on the input side, the MD player 3 logically connects the logical output plug 4B of the audio amp 4 with the logical input plug 3A of the MD player 3.

Thus, the AV system 1 can input the audio data output from the logical output plug 5B of the CD player 5 to the logical input plug 3A of the MD player 3 via a path through, in sequence, the IEEE1394 serial bus 2, the audio amp 4 and the IEEE1394 serial bus 2.

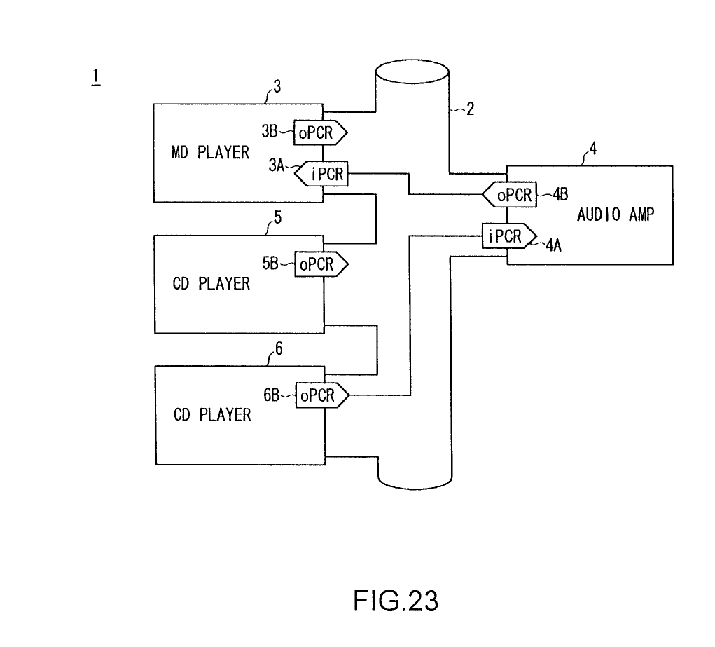

In this state, as shown in FIG. 23, if the user operation specifies the CD player 6 as an AV apparatus on the output side, the CPU 10 of the audio amp 4 releases the logical connection of the logical output plug 5B of the CD player 5 to the logical input plug 4A of the audio amp 4, and logically connects the logical output plug 6B of the CD player 6 with the logical input plug 4A of the audio amp 4.

Thus, the AV system 1 can input the audio data output from the logical output plug 6B of CD player 6 to the logical input plug 3A of the MD player 3 via a path through, in sequence, the IEEE1394 serial bus 2, the audio amp 4 and the IEEE1394 serial bus 2.

In the above configuration, the audio amp 4 outputs from the logical output plug 4B the same audio data as that input from the logical input plug 4A, so that the MD player 3 can easily acquire the audio data input to the logical input plug 4A of the audio amp 4 just by logically connecting the logical input plug 3A of the MD player 3 with the logical output plug 4B of the audio amp 4.

Incidentally, when the transmission rate of the audio data output from CD player 5 or 6 changes by control of the audio amp 4, the MD player 3 cannot recognize this change in transmission rate so that it cannot correctly receive the audio data, even if the logical input plug 3A of the MD player 3 and the logical output plug 4B of the audio amp 4 are logically connected.

Thus, when the transmission rate of the audio data output from CD player 5 or 6 changes, the audio amp 4 accumulates the audio data once in the memory 15 and adjusts the transmission rate so that it can output the audio data from the logical output plug 4B to the outside at the normal transmission rate prior to the change, thus allowing the MD player 3 to correctly receive the audio data output from CD player 5 or 6 via the audio amp 4.

According to the above configuration, where the same audio data is output from the logical output plug 4B as that input to the logical input plug 4A of the audio amp 4, it is possible for the MD player 3 to easily acquire the audio data input to the logical input plug 4A of the audio amp 4 just by logically connecting the logical input plug 3A of the MD player 3 with the logical output plug 4B of the audio amp 4, and thus it can further reduce processing in the network as compared with conventional methods.

Moreover, while the above embodiment describes a case where the AV system 1 is constructed by connecting the MD player 3, the audio amp 4, and CD players 5 and 6 to the IEEE1394 serial bus 2, this invention is not limited thereto but it also allows other various AV apparatus such as a VTR (Video Tape Recorder) and a DVD (Digital Versatile Disk) to be connected to the IEEE1394 serial bus 2 so as to construct an information processing system.

In addition, while the above embodiment describes a case where audio data is transmitted among the AV apparatus, this invention is not limited thereto but it also allows other various data such as video data to be transmitted.

As mentioned above, according to this invention, information transmitted to an information processing apparatus from an information sending apparatus via a transmission channel is transmitted to an information receiving apparatus from the information processing apparatus via a transmission channel established between the information receiving apparatus and the information processing apparatus, so that the information receiving apparatus can easily acquire the information input to the inputting means of the information processing apparatus, and thus it can further reduce processing in the network as compared with conventional methods.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An information processing system for transmitting information among an information sending apparatus, an information processing apparatus and an information receiving apparatus all connected to an information transmitting system having a plurality of transmission channels, including a first transmission channel operable to send said information from said information sending apparatus to said information processing apparatus, said information processing system comprising:
an input unit connected to said information transmitting system;
an output unit connected to said information transmitting system;
an information supply unit operable to supply said information from said input unit to said output unit;
means for establishing a second transmission channel in said information transmitting system between said information processing apparatus and said information receiving apparatus; and
means for transmitting said information from said information processing apparatus to said information receiving apparatus via said second transmission channel.

2. The information processing system according to claim 1, wherein said information transmitting system includes an IEEE1394 serial bus interface.

3. The information processing system according to claim 1, wherein said means for establishing said second transmission channel acquires a band and a transmission channel required for transmitting said information from said information transmitting system.

4. The information processing system according to claim 1, wherein said input unit comprises a logical input plug and said output unit comprises a logical output plug, and said information supplying unit connects said logical input plug with said logical output plug.

5. The information processing system according to claim 4, wherein said logical input plug and said logical output plug each include a register.

6. In an information processing system for transmitting information among at least an information sending apparatus, an information processing apparatus and an information receiving apparatus all connected to an information transmitting system having a plurality of transmission channels, including a first transmission channel operable to send said information from said information sending apparatus to said information processing apparatus, said information processing apparatus comprising:
an input unit connected to said information transmitting system;
an output unit connected to said information transmitting system; and
an information supply unit operable to supply said information from said input unit to said output unit;
said information processing apparatus being operable to transmit said information to said information receiving apparatus via a second transmission channel established in said information transmitting system between said information receiving apparatus and said information processing apparatus.

7. The information processing apparatus according to claim 6, wherein said information transmitting system includes an IEEE1394 serial bus interface.

8. The information processing apparatus according to claim 6, wherein said input unit comprises a logical input plug and said output unit comprises a logical output plug, and said information supply unit connects said logical input plug with said logical output plug.

9. The information processing apparatus according to claim 8, wherein said logical input plug and said logical output plug each includes a register.

10. The information processing apparatus according to claim 6, further comprising a channel selection unit operable to select a desired transmission channel from said plurality of transmission channels, and to receive said information via said desired transmission channel.

11. The information processing apparatus according to claim 6, wherein
said information supply unit is operable to adjust a transmission rate of said information input from said input unit and to supply said information with said adjusted transmission rate to said output unit.

12. An information processing system, comprising:
an information transmitting system having a plurality of transmission channels;
an information sending apparatus connected to said information transmitting system;
an information processing apparatus connected to said information transmitting system;
an information receiving apparatus connected to said information transmitting system;
means for establishing a first transmission channel in said information transmitting system between said information processing apparatus and said information sending apparatus;
means for establishing a second transmission channel in said information transmitting system between said information processing apparatus and said information receiving apparatus;
means for transmitting information from said information sending apparatus to said information processing apparatus via said first transmission channel; and
means for transmitting said information from said information processing apparatus to said information receiving apparatus via said second transmission channel.

13. The information processing system according to claim 12, further comprising:
an input unit connected to said information transmitting system;
an output unit connected to said information transmitting system; and
an information supply unit operable to supply said information from said input unit to said output unit.

14. The information processing system according to claim 13, further comprising a plurality of information sending apparatus connected to said information transmitting system, each information sending unit operable to transmit information to said information processing apparatus via one of said plurality of transmission channels, wherein said information processing apparatus includes a selection unit operable to receive information from a selected one of said information sending apparatus by selecting a desired transmission channel corresponding to said selected one of said information sending apparatus from said plurality of transmission channels.

15. The information processing system according to claim 13, wherein said information supply unit includes a transmission rate adjusting unit operable to adjust a transmission rate of said information input from said input unit and to output said information with said adjusted transmission rate to said output unit.

16. An information processing method for transmitting information among an information sending apparatus, an information processing apparatus and an information receiving apparatus all connected to an information transmitting system having a plurality of transmission channels, comprising:
transmitting information from said information sending apparatus to said information processing apparatus via a first transmission channel in said information transmitting system;
establishing a second transmission channel in said information transmitting system between said information processing apparatus and said information receiving apparatus; and
transmitting said information from said information processing apparatus to said information receiving apparatus via said second transmission channel.

17. The information processing method according to claim 16, wherein said information transmitting system includes an IEEE1394 serial bus interface.

18. The information processing method according to claim 16, wherein said step of establishing said second transmission channel includes acquiring a band and a transmission channel required for transmitting said information from said information transmitting system.

19. The information processing method according to claim 16, further comprising:
inputting said information via an input unit connected to said information transmitting system; and
supplying said information from said input unit to an output unit connected to said information transmitting system.

20. The information processing method according to claim 19, wherein said input unit comprises a logical input plug and said output unit comprises a logical output plug, and said supplying step supplies said information by connecting said logical input plug with said logical output plug.

21. The information processing method according to claim 19, further comprising adjusting a transmission rate of said information input from said input unit and supplying said information with said adjusted transmission rate to said output unit.

22. The information processing method according to claim 16, further comprising selecting a desired transmission channel from said plurality of transmission channels and receiving said information in said information processing apparatus via said desired transmission channel.

23. An information processing method, comprising:
providing an information transmitting system having a plurality of transmission channels;
connecting an information sending apparatus to said information transmitting system;
connecting an information processing apparatus to said information transmitting system;
connecting an information receiving apparatus to said information transmitting system;
establishing a first transmission channel in said information transmitting system between said information processing apparatus and said information sending apparatus;
establishing a second transmission channel in said information transmitting system between said information processing apparatus and said information receiving apparatus;
transmitting information from said information sending apparatus to said information processing apparatus via said first transmission channel; and
transmitting said information from said information processing apparatus to said information receiving apparatus via said second transmission channel.

24. The information processing method according to claim 23, wherein said information transmitting system includes an IEEE1394 serial bus interface.

25. The information processing method according to claim 23, further comprising:
inputting said information via an input unit connected to said information transmitting system, and supplying said information from said input unit to an output unit connected to said information transmitting system.

26. The information processing method according to claim 25, wherein said input unit comprises a logical input plug and said output unit comprises a logical output plug, and said supplying step supplies said information by connecting said logical input plug with said logical output plug.

27. The information processing method according to claim 25, further comprising adjusting a transmission rate of said information input from said input unit and supplying said information with said adjusted transmission rate to said output unit.

28. The information processing method according to claim 23, further comprising selecting a desired transmission channel from said plurality of transmission channels and receiving said information in said information processing apparatus via said desired transmission channel.
